(19) United States
(12) Patent Application Publication
(10) Pub. No.: US 2018/0074648 A1
(43) Pub. Date: Mar. 15, 2018

(54) TAPPING DETECTING DEVICE, TAPPING DETECTING METHOD AND SMART PROJECTING SYSTEM USING THE SAME

(71) Applicant: INDUSTRIAL TECHNOLOGY RESEARCH INSTITUTE, Hsinchu (TW)

(72) Inventors: Fu-Song HSU, Changhua City (TW); Te-Mei WANG, Hsinchu City (TW)

(21) Appl. No.: 15/377,063

(22) Filed: Dec. 13, 2016

(30) Foreign Application Priority Data
Sep. 12, 2016 (TW) 105129595

(51) Int. Cl. G06F 3/041; G06F 3/042; G06T 7/521

(52) U.S. Cl. CPC G06F 3/0418; G06F 3/0421; G06T 2207/10028; G06T 7/521; G06F 3/0425

(57) ABSTRACT

A tapping detecting device, a tapping detecting method and a smart projecting system using the same are provided. The tapping detecting device comprises a fingertip size providing unit, a laser emitting unit, a laser sensing unit and a processing unit. The fingertip size providing unit is used for providing the size of a fingertip of a finger. The laser emitting unit is used for providing a laser at a parallel surface above a plane. The laser sensing unit is used for capturing a reflecting image which shows the reflection of the laser caused by the fingertip. The processing unit is used for obtaining a reflecting region according to the reflecting image, and for adjusting a threshold value according to the size of the fingertip. If the area of the reflecting region is larger than the threshold value, then the processing unit deems that the fingertip touches the plane.

This application claims the benefit of Taiwan application Serial No. 105129595, filed Sep. 12, 2016, the disclosure of which is incorporated by reference herein in its entirety.

### TECHNICAL FIELD

The disclosure relates in general to a tapping detecting device, a tapping detecting method and a smart projecting system using the same.

### BACKGROUND

Along with the development of technology, various intuitive control interfaces are invented. For example, in one intuitive control interface, controlling actions could be realized by detecting whether a fingertip of a finger touches a plane.

However, different users whose sizes of their fingertips are different may use the control interface. Even if the same user uses the control interface, the sizes of his thumb and little finger are different. Therefore, the sensor cannot accurately detect the fingertip.

### SUMMARY

According to one embodiment, a taping detecting method is provided. The taping detecting method comprises the following steps: A size of a fingertip of at least one finger is provided. A laser is provided at a parallel surface above a plane. A reflecting image, which shows a reflection of the laser caused by the fingertip, is captured. A reflecting region is obtained according to the reflecting image. A threshold value is adjusted according to the size of the fingertip. Whether the area of the reflecting region is larger than the threshold value is determined. If the area of the reflecting region is larger than the threshold value, it is deemed that the fingertip touches the plane.

According to another embodiment, a tapping detecting device is provided. The tapping detecting comprises a fingertip size providing unit, a laser emitting unit, a laser sensing unit and a processing unit. The fingertip size providing unit is for providing a size of a fingertip of a finger. The laser emitting unit is for providing a laser at a parallel surface above a plane. The laser sensing unit is for capturing a reflecting image which shows a reflection of the laser caused by the fingertip. The processing unit is for obtaining a reflecting region according to the reflecting image, and is adjusting a threshold value according to the size of the fingertip. The processing unit is further for determining whether an area of the reflecting region is larger than the threshold value. If the area of the reflecting region is larger than the threshold value, then the processing unit deems that the fingertip touches the plane.

According to an alternative embodiment, a smart projecting system is provided. The smart projecting system comprises a projecting device and a tapping detecting device. The projecting device is for projecting a frame on a plane. The tapping detecting device comprises a fingertip size providing unit, a laser emitting unit, a laser sensing unit and a processing unit. The fingertip size providing unit is for providing a size of a fingertip of a finger. The laser emitting unit is for providing a laser at a parallel surface above the plane. The laser sensing unit is for capturing a reflecting image which shows a reflection of the laser caused by the fingertip. The processing unit is for obtaining a reflecting region according to the reflecting image, and is for adjusting a threshold value according to the size of the fingertip. The processing unit is further for determining whether an area of the reflecting region is larger than the threshold value. If the area of the reflecting region is larger than the threshold value, then the processing unit deems that the fingertip touches the plane.

### BRIEF DESCRIPTION OF THE DRAWINGS

FIG. 1 shows a block diagram of a smart projecting system according to one embodiment.

FIG. 2 shows the smart projecting system of FIG. 1.

FIG. 3 shows a schematic diagram of a virtual piano.

FIG. 4 shows a flowchart of a tapping detecting method according to one embodiment.

FIG. 5 shows a block diagram of a fingertip size providing unit.

FIG. 6 shows detail steps of the step S110 in FIG. 4.

FIGS. 7A to 7B illustrate those steps in FIG. 6.

FIG. 8 shows a schematic diagram of a reflecting image.

FIG. 9 illustrates a schematic diagram of a tapping detecting device applied for a display panel.

FIG. 10 illustrates a schematic diagram of a tapping detecting device applied for an interactive electronic whiteboard.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

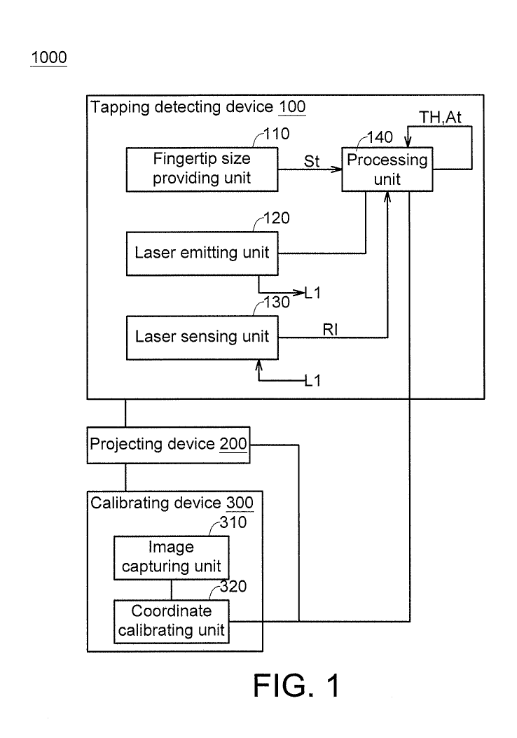

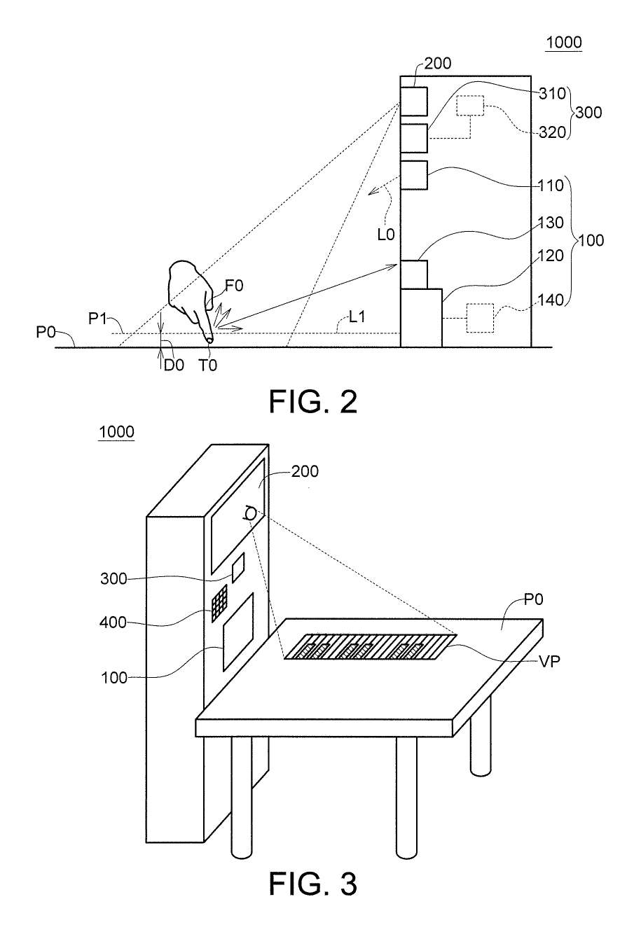

Please refer to FIGS. 1 and 2. FIG. 1 shows a block diagram of a smart projecting system 1000 according to one embodiment. FIG. 2 shows the smart projecting system 1000 of FIG. 1. The smart projecting system 1000 comprises a tapping detecting device 100, a projecting device 200 and a calibrating device 300. The tapping detecting device 100 comprises a fingertip size providing unit 110, a laser emitting unit 120, a laser sensing unit 130 and a processing unit 140. The fingertip size providing unit 110 is for providing the size St of a fingertip. The fingertip size providing unit 110 may be an input device for inputting the size St of the fingertip by the user, a measuring device for instantaneously measuring the size St of the fingertip, or a storage storing the size St of the fingertip in advance. In the present embodiment, the fingertip size providing unit 110 is the measuring device for instantaneously measuring the size St of the fingertip.

The processing unit 140 may be a chip, a circuit board, a circuit, a firmware, or a storage device storing a plurality of program codes for performing various calculating processes, various processing processes or various controlling processes.

The tapping detecting device 100 is connected to the projecting device 200 and the calibrating device 300. The projecting device 200 may be a projector for projecting various images. The calibrating device 300 is for calibrating the coordinate system of the tapping detecting device 100 and the coordinate system of the projecting device 200, such that the coordinate system of the tapping detecting device 100 could be aligned with the coordinate system of the projecting device 200. In the present embodiment, the calibrating device 300 comprises an image capturing unit 310 and a coordinate calibrating unit 320. The image capturing unit 310 may be a color camera or a monochrome camera. The coordinate calibrating unit 320 may be a chip, a circuit board, a circuit, a firmware, or a storage device storing a plurality of program codes for performing a calibrating process.

As shown in FIG. 2, the tapping detecting device 100, the projecting device 200 and the calibrating device 300 could be integrated in single device. The projecting device 200 could project a frame on a plane P0. The user could click, press, or drag on the frame by his finger F0. The calibrating device 300 calibrates the coordinate system according to the point touched by the finger F0 and the point shown on the frame. After calibrating, the tapping detecting device 100 could detect which part of the frame where the user wants to tap according to the correct coordinate system.

Please refer to FIG. 3, which shows a schematic diagram of a virtual piano VP. The smart projecting system 1000 could be applied to a smart table, a smart table lamp, a smart white board, a smart stove, etc. The virtual piano VP is one of the applications of the smart projecting system 1000. When the user presses the key of the virtual piano VP, the tapping detecting device 100 detects the key pressed by the finger, and then the speaker 400 makes the corresponding sound.

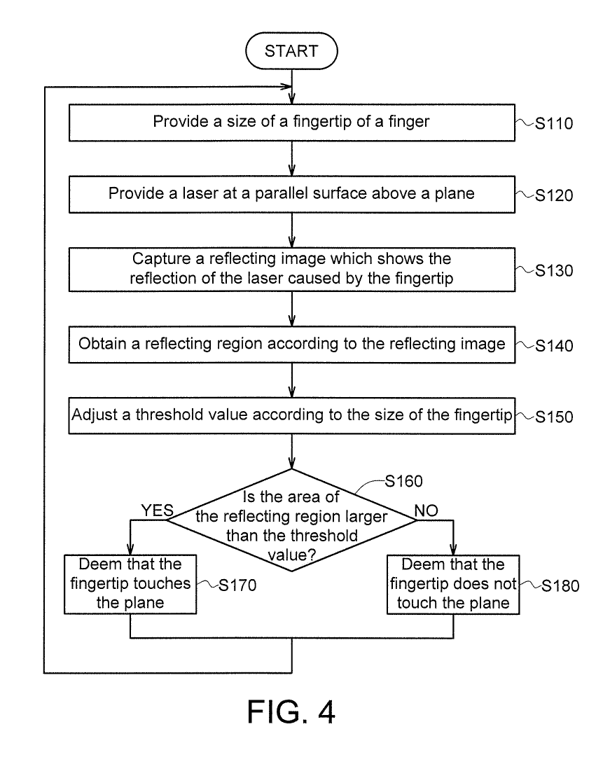

Please refer to FIG. 4, which shows a flowchart of a tapping detecting method according to one embodiment. The flowchart of FIG. 4 is illustrated via the tapping detecting device 100 of FIG. 1. However, the tapping detecting method of the present embodiment is not limited to the tapping detecting device 100 of FIG. 1. And, the sequence of steps of the tapping detecting method of FIG. 4 is not limited thereto.

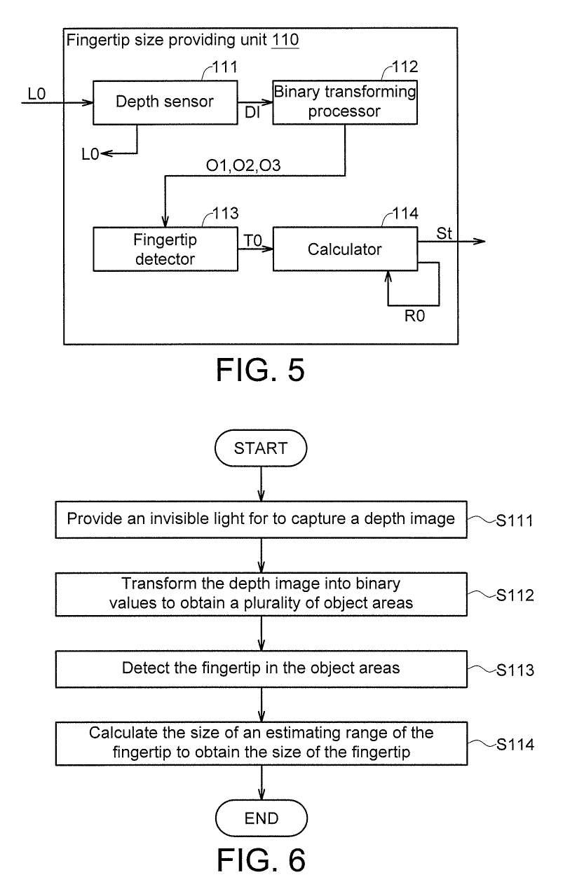

Firstly, in step S110, the fingertip size providing unit 110 provides the size St of the fingertip T0 of the finger F0. In one embodiment, the fingertip size providing unit 110 is the measuring device for instantaneously measuring the size St of the fingertip. Please refer to FIGS. 5 and 6. FIG. 5 shows a block diagram of the fingertip size providing unit 110. FIG. 6 shows detail steps of the step S110 in FIG. 4. The fingertip size providing unit 110 comprises a depth sensor 111, a binary transforming processor 112, a fingertip detector 113 and a calculator 114. The depth sensor 111 may be a depth camera for capturing depth information. The binary transforming processor 112 may be a chip, a circuit, a circuit, a firmware or a storage device storing a plurality of program codes for performing a binary transforming process. The fingertip detector 113 may be a chip, a circuit board, a circuit, a firmware or a storage device storing a plurality of program codes for performing a fingertip detecting process. The calculator 114 may be a chip, a circuit board, a circuit, a firmware, a storage device storing a plurality of program codes for performing a calculating process.

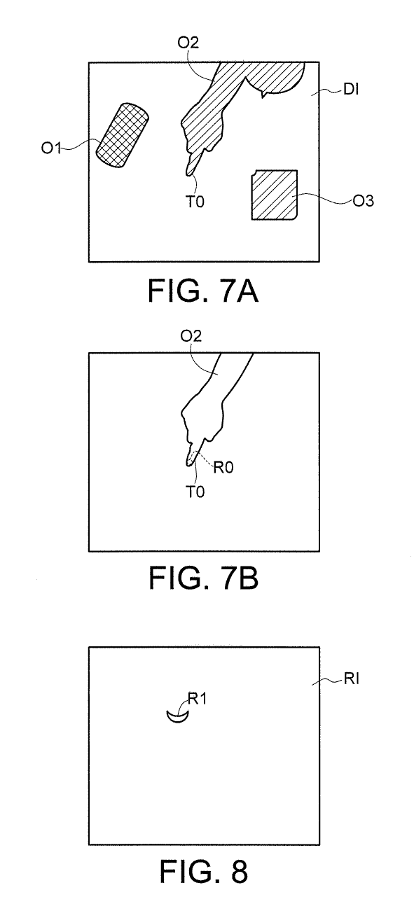

Please refer to FIGS. 7A to 7B, which illustrate those steps in FIG. 6. In step S111, as shown in FIG. 7A, the depth sensor 111 provides an invisible light L0. After the invisible light L0 is reflected by one object, the depth sensor 111 captures a depth image DI. In the depth image D1, different depth values are used to present the different distances of the objects from the depth sensor 111. The depth values may be 0 to 255.

In step S112, the binary transforming processor 112 transforms the depth image DI into binary values to obtain a plurality of object areas O1, O2, O3. In this step, the depth values of the object located above the plane P0 and the depth values of the plane P0 are significantly different, so those object areas O1, O2, O3 could be obtained by the binary transforming process.

In step S113, the fingertip detector 113 detects the fingertip in the object areas O1, O2, O3. In this step, the fingertip detector 113 recognizes the outline of the object area O2 as an arm, a hand or a finger. Then, the end of the object area O2 is deemed as the fingertip T0.

In step S114, the calculator 114 calculates the area of the estimating range R0 of the fingertip T0 to obtain the size St of the fingertip. In this step, the estimating range R0 is an inscribed circle of the fingertip T0.

After performing the steps S111 to S114 of FIG. 6, the step S110 of FIG. 4 is accomplished and the size St of the fingertip T0 of the finger F0 is provided.

Then, as shown in FIG. 2, in the S120 of FIG. 4, a laser L1 is provided at a parallel surface P1 above the plane P0. In this step, a wavelength of the invisible light L0 provided by the depth sensor 111 is different from a wavelength of the laser L1 provided by the laser emitting unit 120, such that the invisible light L0 and the laser L1 will not interfere with each other.

In step, as shown in FIG. 2, a distance D0 between the parallel surface P1 and the plane P0 is less than 5 mm. The parallel surface P1 is quite close to the plane P0, such that the action that the fingertip T0 touches the panel P0 could be determined according to the action that the fingertip T0 touches the laser L1 on the parallel surface P1.

Then, in step S130, the laser sensing unit 130 captures a reflecting image RI which shows a reflection of the laser L1 caused by the fingertip T0. Please refer to FIG. 8, which shows a schematic diagram of the reflecting image RI. The laser L1 is invisible. The laser sensing unit 130 measures any light within the wavelength of the laser L1, to determine whether the laser L1 is reflected by the fingertip T0.

Afterwards, in step S140, the processing unit 140 obtains a reflecting region R1 according to the reflecting image RI.

Then, in step S150, the processing unit 140 adjusts a threshold value TH according to the size St of the fingertip. In this step, the threshold value TH and the size St of the fingertip are positive correlated. That is to say, if the size St of the fingertip obtained in the step S110 becomes large, the processing unit 140 will increases the threshold value TH; if the size St of the fingertip obtained in the step S110 becomes small, the processing unit 140 will decreases the threshold value TH.

Please referring to an equation (1), a weighting value ω is a predetermined value, such as a decimal number between 0 and 1. In one embodiment, the weighting value ω may be 0.4, 0.5 or 0.6.

The threshold value TH equals the weighting value ω multiplied by the size St of the fingertip. That is to say, the threshold value TH and the size St of the fingertip are linear correlated. The threshold value TH may be 0.4 to 0.6 times the size St of the fingertip.

TH=ω*St (1)

Afterwards, in step S160, the processing unit 140 determines whether the area At of the reflecting region R1 is larger than the threshold value TH. If the area At of the reflecting region R1 is larger than the threshold value TH, then the process proceeds to step S170; if the area At of the reflecting region R1 is not larger than the threshold value TH, then the process proceeds to step S180.

Please referring to an equation (2), if the area At is larger than the threshold value TH, the determining result is Tap is 1; if the area At is not larger than the threshold value TH, the determining result is Tap is 0.

$$isTap = \{ \begin{matrix}1 & At > TH \\ 0 & otherwise\end{matrix} \qquad ( 2 )$$

In step S170, the processing unit 140 deems that the fingertip T0 touches the plane P0. In step S180, the processing unit 140 deems that the fingertip T0 does not touch the plane P0. As such, whether the fingertip T0 touches the plane P0 could be accurately determined.

If it is already determined that the fingertip T0 touches the plane P0, the location of the point tapped by the fingertip T0 could be obtained according to the reflecting image RI captured by the laser sensing unit 130, such that the corresponding operation, such as playing the sound of the virtual piano VP, could be performed accordingly.

The steps S110 to S160 are performed once for each cycle. Before each performing the step S160, the threshold value TH is adjusted according to the size St of the current fingertip. Therefore, even if the user alternately uses fingers of different sizes, such as the thumb and the little finger, to touch the plane P0, the tapping detecting device 100 still could adjusts the threshold value TH according to the different sizes St of the different fingertips. As such, the tapping detecting becomes more accurate.

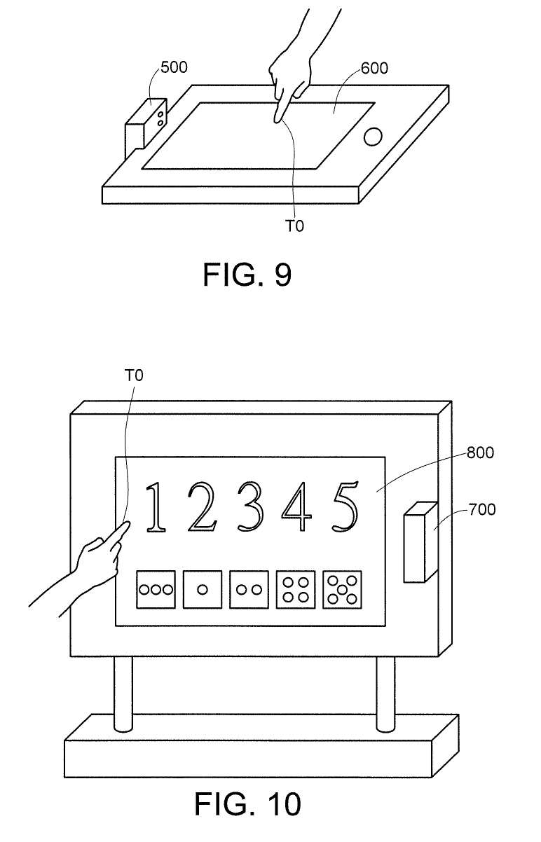

Moreover, the tapping detecting device 100 may not be only applied for the smart projecting system 1000, but also for other applications without the projecting device 200. Please refer to FIG. 9, which illustrates a schematic diagram of a tapping detecting device 500 applied for a display panel 600. The tapping detecting device 500 may be applied for the display panel 600, to substitute the touch panel. After showing a frame on the display panel 600, the user may tap on the frame, and the tapping detecting device 500 detects whether the fingertip T0 touches the display panel 600 and obtains the location of the point the display panel 600 tapped by the fingertip T0.

Then, please refer to FIG. 10, which illustrates a schematic diagram of a tapping detecting device 700 applied for an interactive electronic whiteboard 800. The tapping detecting device 700 may be applied for the interactive electronic whiteboard 800. The user may tap on the interactive electronic whiteboard 800, and the tapping detecting device 700 detects whether the fingertip T0 touches the interactive electronic whiteboard 800 and obtain the point of the interactive electronic whiteboard 800 tapped by the fingertip T0.

According to various embodiments of the tapping detecting devices 100, 500, 700, the tapping detecting method and the smart projecting system 1000 using the same, the size St of the fingertip is adjusted according to the threshold value TH, such that whether the fingers F0 having different sizes touch the plane P0 could be determined to accurately perform the tapping detection.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A taping detecting method, comprising:
providing a size of a fingertip of at least one finger;
providing a laser at a parallel surface above a plane;
capturing a reflecting image which shows a reflection of the laser caused by the fingertip;
obtaining a reflecting region according to the reflecting image;
adjusting a threshold value according to the size of the fingertip;
determining whether an area of the reflecting region is larger than the threshold value; and
deeming that the fingertip touches the plane, if the area of the reflecting region is larger than the threshold value.

2. The tapping detecting method according to claim 1, wherein in the step of providing the size of the fingertip of the finger, the size of the fingertip is obtained according to a depth image.

3. The tapping detecting method according to claim 1, wherein the step of providing the size of the fingertip of the finger comprises:
providing an invisible light to capture a depth image;
transforming the depth image into binary values to obtain a plurality of object areas;
detecting the fingertip in the object areas; and
calculating the size of an estimating range of the fingertip to obtain the size of the fingertip.

4. The tapping detecting method according to claim 3, wherein the estimating range is an inscribed circle of the fingertip.

5. The tapping detecting method according to claim 3, wherein a wavelength of the invisible light is different from a wavelength of the laser.

6. The tapping detecting method according to claim 1, wherein the threshold value and the size of the fingertip are positive correlated.

7. The tapping detecting method according to claim 1, wherein the threshold value and the size of the fingertip are linear correlated.

8. The tapping detecting method according to claim 1, wherein the threshold value is 0.4 to 0.6 times the size of the fingertip.

9. The tapping detecting method according to claim 1, wherein a distance between the parallel surface and the plane is less than 5 mm.

10. A tapping detecting device, comprising:
a fingertip size providing unit for providing a size of a fingertip of a finger;
a laser emitting unit for providing a laser at a parallel surface above a plane;
a laser sensing unit for capturing a reflecting image which shows a reflection of the laser caused by the fingertip; and
a processing unit for obtaining a reflecting region according to the reflecting image, and adjusting a threshold value according to the size of the fingertip;
wherein the processing unit is further for determining whether an area of the reflecting region is larger than the threshold value; if the area of the reflecting region is larger than the threshold value, then the processing unit deems that the fingertip touches the plane.

11. The tapping detecting device according to claim 10, wherein the fingertip size providing unit obtains the size of the fingertip according to a depth image.

12. The tapping detecting device according to claim 10, wherein the fingertip size providing unit comprises:
a depth sensor for providing an invisible light to capture a depth image;
a binary transforming processor for transforming the depth image into binary values to obtain a plurality of object areas;
a fingertip detector for detecting the fingertip in the object areas; and
a calculator for calculating the size of an estimating range of the fingertip to obtain the size of the fingertip.

13. The tapping detecting device according to claim 12, wherein the estimating range is an inscribed circle.

14. The tapping detecting device according to claim 12, wherein a wavelength of the invisible light is different from a wavelength of the laser.

15. The tapping detecting device according to claim 10, wherein the threshold value and the size of the fingertip are positive correlated.

16. The tapping detecting device according to claim 10, wherein the threshold value and the size of the fingertip are linear correlated.

17. The tapping detecting device according to claim 10, wherein the threshold value is 0.4 to 0.6 times the size of the fingertip.

18. The tapping detecting device according to claim 10, wherein a distance between the parallel surface and the plane is less than 5 mm.

19. A smart projecting system, comprising:
a projecting device for projecting a frame on a plane; and
a tapping detecting device, comprising:
a fingertip size providing unit for providing a size of a fingertip of a finger;
a laser emitting unit for providing a laser at a parallel surface above the plane;
a laser sensing unit for capturing a reflecting image which shows a reflection of the laser caused by the fingertip; and
a processing unit for obtaining a reflecting region according to the reflecting image, and adjusting a threshold value according to the size of the fingertip;
wherein the processing unit is further for determining whether an area of the reflecting region is larger than the threshold value; if the area of the reflecting region is larger than the threshold value, then the processing unit deems that the fingertip touches the plane.

20. The smart projecting system according to claim 19, further comprising:
a calibrating device for calibrating a coordinate system of the tapping detecting device and a coordinate system of the projecting device.
